(19) United States
(12) Patent Application Publication
(10) Pub. No.: US 2024/0241779 A1
(43) Pub. Date: Jul. 18, 2024

(54) SIGNALING HOST KERNEL CRASHES TO DPU

(71) Applicant: VMware, Inc., Palo Alto, CA (US)

(72) Inventors: Jared McNeill, Quispamsis (CA); Rohith Jagannathan, Milpitas, CA (US); Andrei Evgenievich Warkentin, South Elgin, IL (US); Renaud Benjamin Voltz, Grass Valley, CA (US); Shruthi Muralidhara Hiriyuru, Arlington, MA (US); Cyprien Laplace, Boston, MA (US)

(21) Appl. No.: 18/097,784

(22) Filed: Jan. 17, 2023

(51) Int. Cl. G06F 11/07

(52) U.S. Cl. CPC G06F 11/0772; G06F 11/0751; G06F 11/0793

(57) ABSTRACT

Disclosed are various examples of signaling host kernel crashes to a data processing unit (DPU) management operating system (OS). A host kernel crash handler is installed to a host device. A crash of a host kernel of the host device is detected. This triggers the host kernel crash handler to provide the signal to the DPU device, which executes a DPU side crash handling process based on the signal.

### BACKGROUND

Management Enterprises can employ a management service that uses virtualization to provide the enterprise with access to software, data, and other resources. The management service uses host devices to execute workloads that provide software services for enterprise activities. The enterprises can use other host devices to access these workloads.

Data processing units (DPUs) can be physically installed to the various host devices. These DPUs can include processors, a network interface, and in many cases can include acceleration engines capable of machine learning, networking, storage, and artificial intelligence processing. The DPUs can include processing, networking, storage, and accelerator hardware. However, DPUs can pose problems for management services and enterprises that desire to fully utilize the capabilities of DPUs in host devices.

For example, crashes on the host side can be difficult to signal to attached DPUs. For example, a host kernel crash can affect communication channels provided by the host kernel, and can prevent effective host side kernel crash signaling. There is a need for better mechanisms that can provide a DPU with effective host side crash signaling in a virtualization and management solution.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of an example of a networked environment that includes components that provide host kernel crash signaling to data processing units (DPUs), according to the present disclosure.

FIG. 2 is a sequence diagram that provides an example of the operation of components of the networked environment of FIG. 1, according to the present disclosure.

FIG. 3 is a flowchart illustrating functionality implemented by components of the networked environment, according to the present disclosure.

FIG. 4 is a flowchart illustrating functionality implemented by components of the networked environment, according to the present disclosure.

### DETAILED DESCRIPTION

The present disclosure relates to signaling data processing units (DPUs) of crashes of a host kernel executed by a host. The DPU or DPUs can be physically installed to a port or bus of the host device. The DPU can include processors, a network interface, and in many cases can include acceleration engines capable of machine learning, networking, storage, and artificial intelligence processing. The interface and general operation can differ from DPU to DPU. This can pose problems for management services and enterprises that desire to fully utilize the capabilities of DPUs in host devices. Further, crashes on the host side such as hypervisor crashes can be difficult to signal to attached DPUs. A host kernel crash can affect communication channels provided by the host kernel, and can prevent effective host side crash signaling. While a system could treat a link down or timeout event on the kernel-to-kernel (host kernel-to-DPU kernel) communication channel as an indicator of a host kernel crash to the DPU kernel, this can result in false positives. The kernel-to-kernel communication interface can temporarily go down as part of regular management operations such as networking reconfiguration, SR-IOV reconfiguration, and other operations. This can occur, for example, when the interface functionality is multiplexed over the same networking hardware as the regular I/O path. However, the present disclosure describes mechanisms that can provide effective host side crash signaling to attached DPUs, even if a communication channel is down, and without using a link down or timeout event of the host-DPU communication channel.

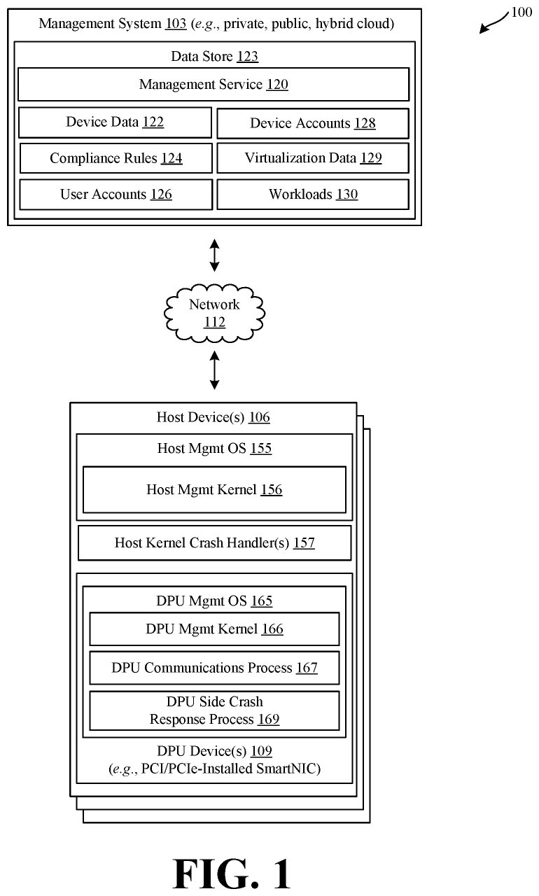

With reference to FIG. 1, shown is an example of a networked environment 100. The networked environment 100 can include a management system 103, host devices 106, and other components in communication with one another over a network 112. One or more DPU devices 109 can be installed to each of the host devices 106. In some cases, host devices 106 can include computing devices or server computing devices of a private cloud, public cloud, hybrid cloud, and multi-cloud infrastructures. Hybrid cloud infrastructures can include public and private host computing devices. Multi-cloud infrastructures can include multiple different computing platforms from one or more service providers in order to perform a vast array of enterprise tasks.

The host devices 106 can also include devices that can connect to the network 112 directly or through an edge device or gateway. The components of the networked environment 100 can be utilized to provide virtualization solutions in an enterprise. The hardware of the host devices 106 can include physical memory, physical processors, physical data storage, and physical network resources that can be utilized by virtual machines. Host devices 106 can also include peripheral components such as the DPU devices 109. The host devices 106 can include physical memory, physical processors, physical data storage, and physical network resources. Virtual memory, virtual processors, virtual data storage, and virtual network resources of a virtual machine can be mapped to physical memory, physical processors, physical data storage, and physical network resources of the host devices 106.

The host management operating system 155 can provide access to the physical memory, physical processors, physical data storage, and physical network resources of the host devices 106 to perform workloads 130. The host management operating system 155 can include a number of software components that work in concert for management of the host device 106. The components of the host management operating system 155 can include a bootloader, a host management kernel 156, and a host management hypervisor, among other components. An example of the host management operating system 155 can include VMWARE ESXI®. The host management kernel 156 can provide a number of functionalities, including a kernel-to-kernel communications channel along with the DPU management kernel 166 of the DPU management OS 165.

The host management operating system 155 can include or work in concert with one or more host kernel crash handlers 157. A host kernel crash handler 157 can be an error handler that is created during peripheral component interconnect (PCI) enumeration, PCI express (PCIe) enumeration, or another device enumeration or discovery process that discovers and configures peripherals and devices connected to ports of the host device 106. Each host kernel crash handler 157 can be DPU device specific, so multiple handlers 157 can be installed corresponding to multiple different DPU devices 109 connected to the host device 106. A host kernel crash handler 157 can be a PCIe device quirk handler that is registered as an on-panic crash handler in a manner that is specific to a DPU device 109, based on the manufacturer or vendor and model.

A quirk can refer to a custom or bespoke function of a device such as the host device 106 or the DPU device 109. These functions can be custom in that they can be noncompliant or additional to expected operations. A panic can refer to a function or run-time trigger that occurs or is called on error or crash of the host management operating system 155. A panic state can refer to the state of the device, such as the host device 106 and the DPU device 109 that trigger the panic. As a result, an on-panic crash handler can include a bespoke or customized handler that can be invoked when a panic occurs, for example, by the panic function.

When a host management kernel 156 crash or error occurs on the host device 106, the registered host kernel crash handler 157 panic handlers are invoked before any crash output or crash dumps are taken. The crash can correspond to an error, hang, timeout, exception, or other panic state. The crash can include an intentional or unintentional restart or relaunch of the host management kernel 156 in response to the error, hang, timeout, exception, or other panic state.

In some examples, the device discovery process can identify a particular DPU device 109 as a particular DPU device type corresponding to a model, manufacturer/vendor or other manner of device type identification. One or more of the components of the host management operating system 155 can identify that the DPU device type is one that executes the DPU management operating system 165 that enables management by the management service 120. If the DPU device type is one known to execute the DPU management operating system 165, then the host management operating system 155 or associated boot time code can create and enable the host kernel crash handler 157 to communicate with the DPU device 109.

The host kernel crash handler 157 can operate in a number of ways to communicate with the DPU device 109. The host kernel crash handler 157 can manipulate a value or another item in a DPU device 109 physical function PCI, PCIe, or other configuration space. This can cause an interrupt, notification or other measurable event that is delivered to the DPU device 109. The DPU communications process 167, DPU side crash response process 169, or another component associated with the DPU management operating system 165 can monitor for a signal such as a changed value of a VMKernel SysInfo Interface (VSI) key or another key or value. The change in value, transmission, or other signal can trigger a watchdog timer interrupt on the DPU devices 109 that expose watchdogs to the host device 106 through memory mapped input output (MMIO) presented by PCIe base address registers (BARs), software interrupts or general purpose input output (GPIO) interrupts triggered by configuration space writes, and so on. In any case, the host kernel crash handler 157 can provide a signal such as changing a value in memory or transmitting data. A management component of the DPU device 109 can monitor for the signal and once identified, can initiate remedial actions to be performed by the DPU side crash response process 169.

Remedial actions can include transmitting to the management service 120 crash-specific data such as snapshot data or other data indicating states of the DPU device 109 and the host device 106, data specifying an identity of the host device 106 and the DPU device 109, and an indication that a host kernel crash has occurred. Remedial actions can include changing a state of the DPU device 109 to a ready state for startup coordination with the host management operating system 155, a ready state for a power cycle event, or another state.

The management component of the DPU device 109 can refer to the DPU management operating system 165, DPU management kernel 166, DPU communications process 167, DPU side crash response process 169, or another software component executed by the DPU device 109 for management using the management service 120. The DPU side crash response process 169 can be an executable that performs a process specifically for crashes of the host management operating system 155, and can be referred to as a DPU side host kernel crash response process 169.

The DPU devices 109 can include networking accelerator devices, smart network interface cards, or other cards that are installed as a peripheral component. The DPU devices 109 themselves can also include general purpose physical memory, physical processors, physical data storage, and physical network resources. The DPU devices 109 can also include specialized physical hardware that includes accelerator engines for machine learning, networking, storage, and artificial intelligence processing. Virtual memory, virtual processors, virtual data storage, and virtual network resources of a virtual machine can be mapped to physical memory, physical processors, physical data storage, physical network resources, and physical accelerator resources of the DPU devices 109.

The DPU management operating system 165 can communicate with the host management operating system 155 and/or with the management service 120 directly to provide access to the physical memory, physical processors, physical data storage, physical network resources, and physical accelerator resources of the DPU devices 109 in order to perform workloads 130. The DPU management operating system 165 can include a DPU-specific management operating system or management hypervisor. The DPU management operating system 165 can be a kernel-level software component of the DPU device 109. The DPU management operating system 165 can include the ability to provide the host device 106, and in some cases devices in communication over a network 112, with access to the specialized accelerator engines of the DPU device 109 as well as its other processors, memories, and network components. The DPU management operating system 165 can include the ability to virtualize the physical specialized accelerator engines of the DPU device 109, as well as the other processors, memories, and network components.

The DPU management operating system 165 can include a DPU management kernel 166, a DPU communications process 167 and a DPU side crash response process 169. In some examples, the DPU management operating system 165 can include a DPU management hypervisor, but in other examples the DPU management operating system 165 can omit or lack a hypervisor. The DPU communications process 167 can include a background process executed in user space or kernel space of the DPU device 109, which enables communications between the DPU management operating system 165 and the host management operating system 155 from the DPU side. In some examples, this can include or be referred to as a kernel-to-kernel communications channel between the DPU management operating system 165 and the host management operating system 155. However, in other cases the DPU communications process 167 can be separate from the kernel-to-kernel communications channel. The kernel-to-kernel communications channel can be provided by and/or between the host management kernel 156 and the DPU management kernel 166.

While not shown, the host management operating system 155 can include a host communications process, which can include a background daemon process executed in user space or a kernel space process of the host device 106. The host communications daemon can enable communications between the DPU management operating system 165 and the host management operating system 155 from the host side. The DPU side crash response process 169 can be a DPU-based or DPU-executed software component that performs remedial actions such as storing data, resetting the DPU device 109, and otherwise changing states of the DPU device 109 in response to an error or crash of the host management kernel 156 of the host device 106 to which the DPU device 109 is connected.

Virtual devices including virtual machines, containers, and other virtualization components can be used to execute the workloads 130. The workloads 130 can be managed by the management service 120 in an enterprise that employs the management service 120. Some workloads 130 can be initiated and accessed by enterprise users through client devices. The virtualization data 129 can include a record of the virtual devices, as well as the host devices 106 and DPU devices 109 that are mapped to the virtual devices. The virtualization data 129 can also include a record of the workloads 130 that are executed by the virtual devices.

The network 112 can include the Internet, intranets, extranets, wide area networks (WANs), local area networks (LANs), wired networks, wireless networks, other suitable networks, or any combination of two or more such networks. The networks can include satellite networks, cable networks, Ethernet networks, telephony networks, and other types of networks.

The management system 103 can include one or more host or server computers, and any other system providing computing capability. In some examples, a subset of the host devices 106 can provide the hardware for the management system 103. While referred to in the singular, the management system 103 can include a plurality of computing devices that are arranged in one or more server banks, computer banks, or other arrangements. The management system 103 can include a grid computing resource or any other distributed computing arrangement. The management system 103 can be multi-tenant, providing virtualization and management of workloads 130 for multiple different enterprises. Alternatively, the management system 103 can be customer or enterprise-specific.

The computing devices of the management system 103 can be located in a single installation or can be distributed among many different geographical locations which can be local and/or remote from the other components. The management system 103 can also include or be operated as one or more virtualized computer instances. For purposes of convenience, the management system 103 is referred to herein in the singular. Even though the management system 103 is referred to in the singular, it is understood that a plurality of management systems 103 can be employed in the various arrangements as described above.

The components executed on the management system 103 can include a management service 120, as well as other applications, services, processes, systems, engines, or functionality not discussed in detail herein. The management service 120 can be stored in the data store 123 of the management system 103. While referred to generally as the management service 120 herein, the various functionalities and operations discussed can be provided using a management service 120 that includes a scheduling service and a number of software components that operate in concert to provide compute, memory, network, and data storage for enterprise workloads and data. The management service 120 can also provide access to the enterprise workloads and data executed by the host devices 106 and can be accessed using client devices that can be enrolled in association with a user account 126 and related credentials.

The management service 120 can communicate with associated management instructions executed by host devices 106, client devices, edge devices, and IoT devices to ensure that these devices comply with their respective compliance rules 124, whether the specific host device 106 is used for computational or access purposes. If the host devices 106 or client devices fail to comply with the compliance rules 124, the respective management instructions can configure and perform remedial actions including discontinuing access to and processing of workloads 130.

The data store 123 can include any storage device or medium that can contain, store, or maintain the instructions, logic, or applications described herein for use by or in connection with the instruction execution system. The data store 123 can be a hard drive or disk of a host, server computer, or any other system providing storage capability. While referred to in the singular, the data store 123 can include a plurality of storage devices that are arranged in one or more hosts, server banks, computer banks, or other arrangements. The data store 123 can include any one of many physical media, such as magnetic, optical, or semiconductor media. More specific examples include solid-state drives or flash drives. The data store 123 can include a data store 123 of the management system 103, mass storage resources of the management system 103, or any other storage resources on which data can be stored by the management system 103. The data store 123 can also include memories such as RAM used by the management system 103. The RAM can include static RAM (SRAM), dynamic RAM (DRAM), synchronous DRAM (SDRAM), and other types of RAM.

The data stored in the data store 123 can include management data including device data 122, enterprise data, compliance rules 124, user accounts 126, and device accounts 128, as well as other data. Device data 122 can identify host devices 106 by one or more device identifiers, a unique device identifier (UDID), a media access control (MAC) address, an internet protocol (IP) address, or another identifier that uniquely identifies a device with respect to other devices.

The device data 122 can include an enrollment status indicating whether a computing device, such as a host device 106 or a DPU device 109, is enrolled with or managed by the management service 120. For example, an end-user device, an edge device, IoT device, host device 106, client device, or other devices can be designated as “enrolled” and can be permitted to access the enterprise workloads and data hosted by host devices 106, while those designated as “not enrolled,” or having no designation, can be denied access to the enterprise resources. The device data 122 can further include indications of the state of IoT devices, edge devices, end user devices, host device 106, DPU devices 109 and other devices.

For example, the device data 122 can indicate that a host device 106 includes a DPU device 109 in which a DPU management operating system 165 is installed. This can enable providing remotely-hosted management services to the host device 106 through or using the DPU device 109. The device data 122 can be transmitted to the host device 106 or can be accessible to the host management operating system 155, and can specify DPU device types that include the DPU management operating system 165. Remotely-hosted management services can also include providing management services to other remotely-located client or host devices 106 using resources of the DPU device 109. While a user account 126 can be associated with a particular person as well as client devices, a device account 128 can be unassociated with any particular person, and can nevertheless be utilized for an IoT device, edge device, or another client device that provides automatic functionalities.

Device data 122 can also include data pertaining to user groups. An administrator can specify one or more of the host devices 106 as belonging to a user group. The user group can refer to a group of user accounts 126, which can include device accounts 128. User groups can be created by an administrator of the management service 120.

Compliance rules 124 can include, for example, configurable criteria that must be satisfied for the host devices 106 and other devices to be in compliance with the management service 120. The compliance rules 124 can be based on a number of factors, including geographical location, activation status, enrollment status, and authentication data, including authentication data obtained by a device registration system, time, and date, and network properties, among other factors associated with each device. The compliance rules 124 can also be determined based on a user account 126 associated with a user.

Compliance rules 124 can include predefined constraints that must be met in order for the management service 120, or other applications, to permit host devices 106 and other devices access to enterprise data and other functions of the management service 120. The management service 120 can communicate with management instructions on the client device to determine whether states exist on the client device which do not satisfy one or more of the compliance rules 124. States can include, for example, a virus or malware being detected; installation or execution of a blacklisted application; and/or a device being “rooted” or “jailbroken,” where root access is provided to a user of the device. Additional states can include the presence of particular files, questionable device configurations, vulnerable versions of applications, vulnerable states of the client devices or other vulnerability, as can be appreciated. While the client devices can be discussed as user devices that access or initiate workloads 130 that are executed by the host devices 106, all types of devices discussed herein can also execute virtualization components and provide hardware used to host workloads 130.

The management service 120 can oversee the management and resource scheduling using hardware provided using host devices 106 and DPU devices 109. The management service 120 can oversee the management and resource scheduling of services that are provided to the host devices 106 and DPU devices 109 using remotely located hardware. The management service 120 can transmit various software components, including enterprise workloads, enterprise data, and other enterprise resources for processing and storage using the various host devices 106. The host devices 106 can include host devices 106 such as a server computer or any other system providing computing capability, including those that compose the management system 103. Host devices 106 can include public, private, hybrid cloud and multi-cloud devices that are operated by third parties with respect to the management service 120. The host devices 106 can be located in a single installation or can be distributed among many different geographical locations which can be local and/or remote from the other components.

The host devices 106 can include DPU devices 109 that are connected to the host device 106 through a universal serial bus (USB) connection, a Peripheral Component Interconnect Express (PCI-e) or mini-PCI-e connection, or another physical connection. DPU devices 109 can include hardware accelerator devices specialized to perform artificial neural networks, machine vision, machine learning, and other types of special purpose instructions written using CUDA, OpenCL, C++, and other instructions. The DPU devices 109 can utilize in-memory processing, low-precision arithmetic, and other types of techniques. The DPU devices 109 can have hardware including a network interface controller (NIC), CPUs, data storage devices, memory devices, and accelerator devices.

The management service 120 can include a scheduling service that monitors resource usage of the host devices 106, and particularly the host devices 106 that execute enterprise workloads 130. The management service 120 can also track resource usage of DPU devices 109 that are installed on the host devices 106. The management service 120 can track the resource usage of DPU devices 109 in association with the host devices 106 to which they are installed. The management service 120 can also track the resource usage of DPU devices 109 separately from the host devices 106 to which they are installed.

In some examples, the DPU devices 109 can execute workloads 130 assigned to execute on host devices 106 to which they are installed. For example, the host management operating system 155 can communicate with a DPU management operating system 165 to offload all or a subset of a particular workload 130 to be performed using the hardware resources of a DPU device 109. Alternatively, the DPU devices 109 can execute workloads 130 assigned, by the management service 120, specifically to the DPU device 109 or to a virtual device that includes the hardware resources of a DPU device 109. In some examples, the management service 120 can communicate directly with the DPU management operating system 165, and in other examples the management service 120 can use the host management operating system 155 to communicate with the DPU management operating system 165. The management service 120 can use DPU devices 109 to provide the host device 106 with access to workloads 130 executed using the hardware resources of another host device 106 or DPU device 109.

The host device 106 can include a management component. The management component can communicate with the management service 120 for scheduling of workloads 130 executed using virtual resources that are mapped to the physical resources of one or more host device 106. The management component can communicate with the host management operating system 155 to deploy virtual devices that perform the workloads 130. In various embodiments, the management component can be separate from, or a component of, the host management operating system 155. The management component can additionally or alternatively be installed to the DPU device 109. The management component of a DPU device 109 can be separate from, or a component of, the DPU management operating system 165.

The host management operating system 155 can include a bare metal or type 1 hypervisor that can provide access to the physical memory, physical processors, physical data storage, and physical network resources of the host devices 106 to perform workloads 130. A host management operating system 155 can create, configure, reconfigure, and remove virtual machines and other virtual devices on a host device 106. The host management operating system 155 can also relay instructions from the management service 120 to the DPU management operating system 165. In other cases, the management service 120 can communicate with the DPU management operating system 165 directly. The host management operating system 155 can identify that a workload 130 or a portion of a workload 130 includes instructions that can be executed using the DPU device 109, and can offload these instructions to the DPU device 109.

The DPU management operating system 165 can be a management-service-specific operating system that enables the management service 120 to manage the DPU device 109 and assign workloads 130 to execute using its resources. The DPU management operating system 165 can communicate with the host management operating system 155 and/or with the management service 120 directly to provide access to the physical memory, physical processors, physical data storage, physical network resources, and physical accelerator resources of the DPU devices 109. However, the DPU management operating system 165, or an up-to-date version of the DPU management operating system 165 may not be initially installed to the DPU device 109. In some cases, since the DPU devices 109 can vary in form and function, DPU management operating system 165 can be DPU-device-type specific for a device type such as a manufacturer, product line, or model type of a DPU device 109.

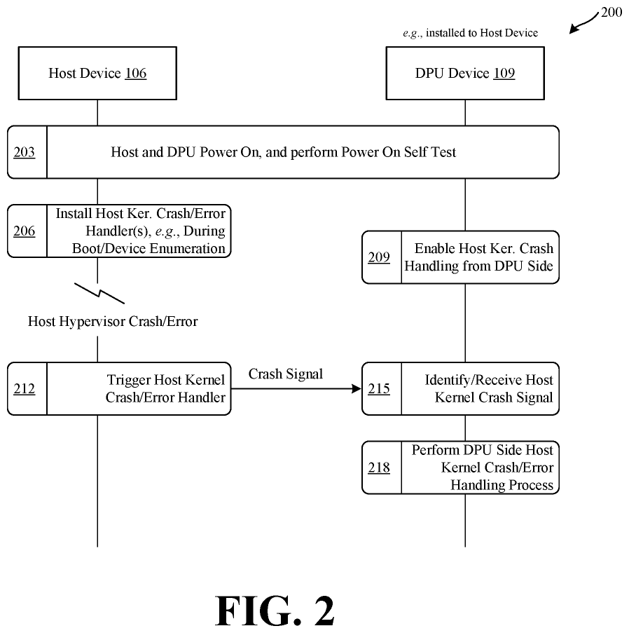

FIG. 2 is a sequence diagram 200 that provides an example of the operation of components of the networked environment 100 to signal crashes of a host management operating system 155 from the host device 106 to the DPU device 109. While a particular step can be discussed as being performed by a particular hardware or software component of the networked environment 100, other components can perform aspects of that step. Generally, this figure shows how the components work in concert to configure mechanisms that can signal crashes of a host management kernel 156, identify the signal on the DPU side, and perform DPU side crash remediation for the host side kernel crash.

In step 203, the host device 106 and the DPU device 109 can perform their power on self tests and other initial boot operations. This process can include a power on or reset of the DPU device 109. For example, a baseboard management controller (BMC) or other component can reset the DPU device 109, or an intentional or unintentional power cycle of the host device 106 can power cycle the DPU device 109.

In step 206, the host device 106 can create host kernel crash handlers 157. A boot time executable such as a bootloader, the host management kernel 156, or another component of the host management operating system 155 can create and install host kernel crash handlers 157 early in boot time, such as during device enumeration. Device enumeration for the host device 106 can identify all devices that are connected as peripherals to the host device 106. The DPU device 109 can be connected to a PCI connector, PCIe connector, or other physical connection to the host device 106.

The enumeration can include identification of a particular DPU device 109 and its functions. The DPU device 109 can be identified as a particular DPU device type corresponding to a model and manufacturer or other manner of device type identification. The host management operating system 155 can determine that the DPU device type is one that executes the DPU management operating system 165 that enables management by the management service 120. The host management operating system 155 can access or include a portion of the device data 122, and can determine that the DPU device type of the DPU device 109 is known to execute the DPU management operating system 165. This can act as confirmation that the DPU device 109 executes the DPU management operating system 165.

The DPU device 109 can have a DPU device type that in some examples can execute the DPU management operating system 165 and in other examples execute another operating system. Some examples can include an additional operating system concurrently with the DPU management operating system 165. In some examples where the DPU device 109 executes an operating system along with or alternatively to the DPU management operating system 165, then the host kernel crash handler 157 is not created for the DPU device 109. As a result, the host management operating system 155 can in some examples transmit and/or receive communications with the DPU management operating system 165 or the DPU communications process 167 to confirm that the DPU device 109 is executing the DPU management operating system 165.

In either case, the host management operating system 155 can create the host kernel crash handler 157 once the DPU device 109 is identified to correspond to a DPU device type that corresponds to one that (1) always executes the DPU management operating system 165, or (2) is capable of executing the DPU management operating system 165. In either case, the host management operating system 155 can create the host kernel crash handler 157. However, in some examples the host kernel crash handler 157 can remain disabled until a communication that confirms the DPU device 109 is executing the DPU management operating system 165 is received from the DPU communications process 167.

In step 209, the DPU device 109 can enable host kernel crash handling from the DPU side. For example, the DPU management operating system 165 can launch a DPU communications process 167 as a kernel-level executable or a user space background process of the DPU device 109. The DPU communications process 167 can work in concert with, and can be considered a part of the DPU management operating system 165. The DPU communications process 167 can transmit a communication to the host management operating system 155 that instructs the host management operating system 155 to enable the host kernel crash handler 157. This step can prevent the host kernel crash handler 157 from being enabled and potentially providing a crash signal that is misinterpreted by a third party operating system as instruction to perform some other functionality.

In step 212, the host kernel crash handler 157 can be triggered based on a crash of the host management kernel 156. When a host management kernel 156 crash occurs on the host device 106, the registered host kernel crash handler 157 panic handlers are invoked before any crash output or crash dumps are taken, to ensure the DPU device 109 detects the fault as soon as possible. The host kernel crash handler 157 can then deliver an interrupt, notification, or other measurable crash signal event to the DPU device 109. This can correspond to delivering an interrupt, notification, or event that is identifiable by the DPU device 109. In some examples, this can include updating a VSI key or writing a predetermined value to a predetermined memory location. The host kernel crash handler 157 implementation can be more effective and accurate since a host management kernel 156 crash can eliminate the kernel-to-kernel communication channel with the DPU management kernel 166, but a link-down type trigger for the kernel-to-kernel communication channel can result in false positives as discussed above.

In step 215, the DPU device 109 can detect or identify the crash signal event indicating a crash of the host management kernel 156. On the DPU side, the crash signal event can be detected using the DPU communications process 167. The DPU communications process 167 can be embodied as kernel code of the DPU management operating system 165 or by an associated user space daemon or background process, depending on the DPU device type and the enterprise implementation of the software support package for the DPU device 109. In some examples, crash signal code executed by the DPU device 109 can detect the interrupt, notification, or other crash signal event, and can set a VSI key to a “crashed” value—either directly in the kernel or using a VSI mechanism if the implementation is in user space. The DPU communications process 167 can monitor for the notification or interrupt directly, or can monitor for a state change of a VSI key or another value written to a predetermined physical or virtual memory location. In other words, the DPU communications process 167 can receive the crash signal event as the notification or interrupt, or can receive the crash signal event as the change in the VSI key or other value written to a monitored memory location.

In step 218, the DPU device 109 can perform a host error handling process. The DPU management operating system 165 or the DPU communications process 167 can invoke or cause the DPU side crash response process 169 to execute. The DPU side crash response process 169 can perform remedial actions such as storing data, resetting the DPU device 109, and otherwise changing states of the DPU device 109 in response to an error or crash of the host management kernel 156 of the host device 106 to which the DPU device 109 is connected.

Remedial actions can include transmitting to the management service 120 crash-specific data such as snapshot data or other data indicating states of the DPU device 109 and the host device 106, data specifying an identity of the host device 106 and the DPU device 109, and an indication that a host kernel crash has occurred. Remedial actions can include changing a state of the DPU device 109 to a ready state for startup coordination with the host management operating system 155, a ready state for a power cycle event, or another state.

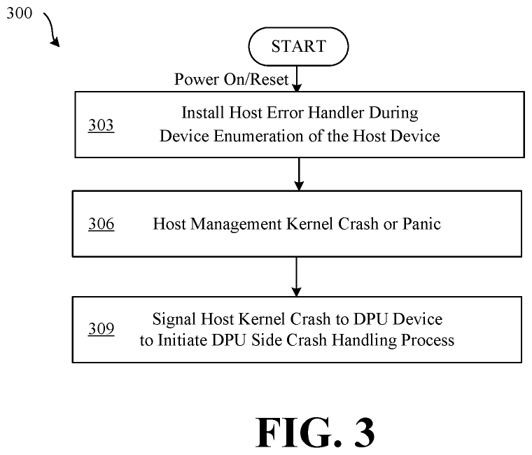

FIG. 3 shows a flowchart 300 that provides an example of the host-side operation of components of the networked environment 100 to signal crashes of a host management kernel 156 from the host device 106 to the DPU device 109. While a particular step can be discussed as being performed by a particular hardware or software component of the networked environment 100, other host side and DPU side components can perform aspects of that step. Generally, this figure shows how the components work in concert to configure mechanisms that can identify crashes of a host management kernel 156 and provide a crash signal to initiate DPU side crash remediation for the host kernel crash.

In step 303, the host device 106 can create host kernel crash handlers 157. The host device 106 and the DPU device 109 can perform their power on self tests and other initial boot operations. A boot time executable such as a bootloader, the host management kernel 156, or another component of the host management operating system 155 can create and install host kernel crash handlers 157 early in boot time, such as during device enumeration. Device enumeration for the host device 106 can identify all devices that are connected as peripherals to the host device 106.

The DPU device 109 can be connected to a PCI connector, PCIe connector, or other physical connection to the host device 106. The enumeration can include identification of a particular DPU device 109 and its functions. The DPU device 109 can be identified as a particular DPU device type corresponding to a model and manufacturer or other manner of device type identification. The host management operating system 155 can determine that the DPU device type is one that executes the DPU management operating system 165. The host management operating system 155 can create the host kernel crash handler 157. In some examples the host kernel crash handler 157 can remain disabled until a communication is received from the DPU communications process 167 that confirms the DPU device 109 is executing the DPU management operating system 165.

In step 306, a host management kernel 156 crash occurs on the host device 106. When a panic state is detected with respect to the host management kernel 156, the host kernel crash handler 157 can be invoked. A panic response can include a panic function or run-time trigger that occurs or is called on error, crash, or panic state of the host management kernel 156. The registered host kernel crash handler 157 panic handlers can be invoked before any crash output or crash dumps are taken, to ensure the DPU device 109 detects the fault as soon as possible.

In step 309, the host kernel crash handler 157 can provide or cause a crash signal event detectable by the DPU device 109. The host kernel crash handler 157 can be triggered based on a crash of the host management kernel 156. The host kernel crash handler 157 can then deliver an interrupt, notification, or other measurable crash signal event to the DPU device 109. This can correspond to delivering an interrupt, notification, or event that is identifiable by the DPU device 109. The host kernel crash handler 157 can then deliver an interrupt, notification, or other measurable crash signal event to the DPU device 109. This can correspond to delivering an interrupt, notification, or event that is identifiable by the DPU device 109. In some examples, this can include updating a VSI key or writing a predetermined value to a predetermined memory location. The DPU communications process 167 can monitor for the notification or interrupt directly, or can monitor for a state change of a VSI key or another value written to a predetermined physical or virtual memory location. The DPU communications process 167 can then trigger execution of the DPU side crash response process 169.

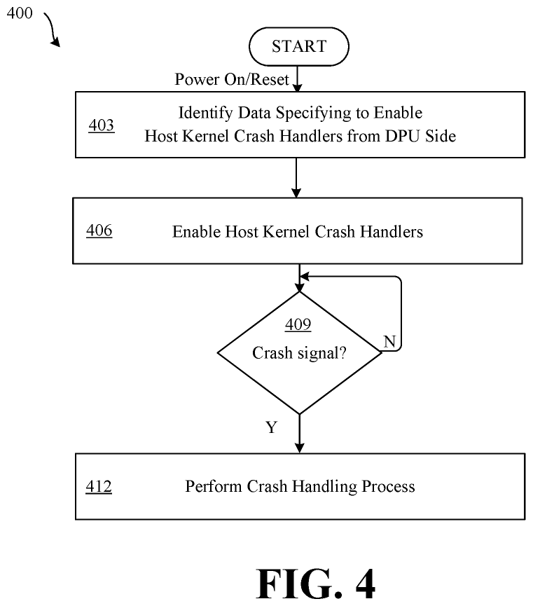

FIG. 4 shows a flowchart 400 that provides an example of the DPU-side operation of components of the networked environment 100 to signal crashes of a host management operating system 155 from the host device 106 to the DPU device 109. While a particular step can be discussed as being performed by a particular hardware or software component of the networked environment 100, other host side and DPU side components can perform aspects of that step. Generally, this figure shows how the components work in concert to configure mechanisms that can identify crashes of a host management kernel 156 and provide a crash signal to initiate DPU side crash remediation for the host kernel crash.

In step 403, the DPU device 109 can identify data specifying to enable host error handlers from the DPU side. The host device 106 and the DPU device 109 can perform their power on self tests and other initial boot operations. This process can include a power on or reset of the DPU device 109. For example, a baseboard management controller (BMC) or other component can reset the DPU device 109, or an intentional or unintentional power cycle of the host device 106 can power cycle the DPU device 109. Data specifying to enable host error handlers can include data indicating that the host device 106 is a trusted device. For example, the management service 120 can transmit a command that indicates the host device 106 is to be considered trusted, or the DPU device 109 can be preconfigured by a vendor or enterprise administrator that can update data stored in the DPU device 109 to indicate that the host device 106. These indicia can indicate that the DPU device 109 is to the enable host error handlers. In various examples, the DPU management operating system 165, the DPU communications process 167, a boot time executable, or another executable process can identify the data specifying to enable host error handlers.

In step 406, the DPU device 109 can enable host kernel crash handling from the DPU side. For example, the DPU communications process 167 can transmit a communication to the host management operating system 155 that instructs the host management operating system 155 to enable the host kernel crash handler 157. This step can prevent the host kernel crash handler 157 from being enabled and potentially providing a crash signal that is misinterpreted by a third party operating system as instruction to perform some other functionality.

The host kernel crash handler 157 can be triggered based on a crash of the host management kernel 156. When a host management operating system 155 crash occurs on the host device 106, the registered host kernel crash handler 157 panic handlers are invoked, and the host kernel crash handler 157 can deliver an interrupt, notification, or other measurable crash signal event to the DPU device 109.

In step 409, the DPU device 109 can determine whether the crash signal event is received or identified, indicating a crash of the host management operating system 155. On the DPU side, the crash signal event can be detected using the DPU communications process 167. The DPU communications process 167 can be embodied as kernel code of the DPU management operating system 165 or by an associated user space daemon or background process, depending on the DPU device type and the enterprise implementation of the software support package for the DPU device 109. In some examples, crash signal code executed by the DPU device 109 can detect the interrupt, notification, or other crash signal event, and can set a VSI key to a “crashed” value—either directly in the kernel or using a VSI mechanism if the implementation is in user space. The DPU communications process 167 can monitor for the notification or interrupt directly, or can monitor for a state change of a VSI key or another value written to a predetermined physical or virtual memory location. In other words, the DPU communications process 167 can receive the crash signal event as the notification or interrupt, or can receive the crash signal event as the change in the VSI key or other value written to a monitored memory location.

In step 412, the DPU device 109 can perform a host crash or error handling process. The DPU management operating system 165 or the DPU communications process 167 can invoke or cause the DPU side crash response process 169 to execute. The DPU side crash response process 169 can perform remedial actions such as storing data, resetting the DPU device 109, and otherwise changing states of the DPU device 109 in response to an error or crash of the host management operating system 155 of the host device 106 to which the DPU device 109 is connected.

Remedial actions can include transmitting to the management service 120 crash-specific data such as snapshot data or other data indicating states of the DPU device 109 and the host device 106, data specifying an identity of the host device 106 and the DPU device 109, and an indication that a host kernel crash has occurred. Remedial actions can include changing a state of the DPU device 109 to a ready state for startup coordination with the host management operating system 155, a ready state for a power cycle event, or another state.

A number of software components are stored in the memory and executable by a processor. In this respect, the term “executable” means a program file that is in a form that can ultimately be run by the processor. Examples of executable programs can be, for example, a compiled program that can be translated into machine code in a format that can be loaded into a random access portion of one or more of the memory devices and run by the processor, code that can be expressed in a format such as object code that is capable of being loaded into a random access portion of the one or more memory devices and executed by the processor, or code that can be interpreted by another executable program to generate instructions in a random access portion of the memory devices to be executed by the processor. An executable program can be stored in any portion or component of the memory devices including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

Memory devices can include both volatile and nonvolatile memory and data storage components. Also, a processor can represent multiple processors and/or multiple processor cores, and the one or more memory devices can represent multiple memories that operate in parallel processing circuits, respectively. Memory devices can also represent a combination of various types of storage devices, such as RAM, mass storage devices, flash memory, or hard disk storage. In such a case, a local interface can be an appropriate network that facilitates communication between any two of the multiple processors or between any processor and any of the memory devices. The local interface can include additional systems designed to coordinate this communication, including, for example, performing load balancing. The processor can be of electrical or of some other available construction.

Although the various services and functions described herein can be embodied in software or code executed by general purpose hardware as discussed above, as an alternative, the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include discrete logic circuits having logic gates for implementing various logic functions upon an application of one or more data signals, application specific integrated circuits (ASICs) having appropriate logic gates, field-programmable gate arrays (FPGAs), or other components.

The sequence diagrams and flowcharts can show examples of the functionality and operation of an implementation of portions of components described herein. If embodied in software, each block can represent a module, segment, or portion of code that can include program instructions to implement the specified logical function(s). The program instructions can be embodied in the form of source code that can include human-readable statements written in a programming language or machine code that can include numerical instructions recognizable by a suitable execution system such as a processor in a computer system or another system. The machine code can be converted from the source code. If embodied in hardware, each block can represent a circuit or a number of interconnected circuits to implement the specified logical function(s).

Although sequence diagrams and flowcharts can be shown in a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the drawings can be skipped or omitted.

Also, any logic or application described herein that includes software or code can be embodied in any non-transitory computer-readable medium for use by or in connection with an instruction execution system such as a processor in a computer system or another system. In this sense, the logic can include, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can include any one of many physical media, such as magnetic, optical, or semiconductor media. More specific examples of a suitable computer-readable medium include solid-state drives or flash memory. Further, any logic or application described herein can be implemented and structured in a variety of ways. For example, one or more applications can be implemented as modules or components of a single application. Further, one or more applications described herein can be executed in shared or separate computing devices or a combination thereof. For example, a plurality of the applications described herein can execute in the same computing device, or in multiple computing devices.

It is emphasized that the above-described embodiments of the present disclosure are merely possible examples of implementations described for a clear understanding of the principles of the disclosure. Many variations and modifications can be made to the above-described embodiments without departing substantially from the spirit and principles of the disclosure. All such modifications and variations are intended to be included in the following claims herein, within the scope of this disclosure.

Therefore, the following is claimed:

1. A non-transitory computer-readable medium comprising executable instructions, wherein the instructions, when executed by at least one processor, cause at least one computing device to at least:
install a host kernel crash handler to a host device, the host kernel crash handler comprising instructions to provide a crash signal to a data processing unit (DPU) device physically connected to the host device;
identify a crash of a host kernel of the host device;
trigger the host kernel crash handler based at least in part on the crash of the host kernel; and
provide, by the host kernel crash handler, the crash signal to the DPU device, causing the DPU device to execute a DPU side crash handling process.

2. The non-transitory computer-readable medium of claim 1, wherein the host kernel crash handler is installed based at least in part on device enumeration of the host device.

3. The non-transitory computer-readable medium of claim 1, wherein the crash corresponds to a panic of the host kernel.

4. The non-transitory computer-readable medium of claim 1, wherein a plurality of host kernel crash handlers are installed corresponding to a plurality of DPU devices physically connected to the host device.

5. The non-transitory computer-readable medium of claim 1, wherein the host kernel crash handler is enabled using the instructions received from the DPU device.

6. The non-transitory computer-readable medium of claim 1, wherein the DPU device and the host device are managed by a single enterprise that uses a management service that communicates with: a DPU management operating system comprising the host kernel, and a DPU management operating system of the DPU device.

7. The non-transitory computer-readable medium of claim 1, wherein a component of a DPU management operating system of the DPU device performs the DPU side crash handling process.

8. A system, comprising:
at least one computing device comprising at least one processor; and
a data store comprising executable instructions, wherein the instructions, when executed by the at least one processor, cause the at least one computing device to at least:
install a host kernel crash handler to a host device, the host kernel crash handler comprising instructions to provide a crash signal to a data processing unit (DPU) device physically connected to the host device;
identify a crash of a host kernel of the host device;
trigger the host kernel crash handler based at least in part on the crash of the host kernel; and
provide, by the host kernel crash handler, the crash signal to the DPU device, causing the DPU device to execute a DPU side crash handling process.

9. The system of claim 8, wherein the host kernel crash handler is installed based at least in part on device enumeration of the host device.

10. The system of claim 8, wherein the crash corresponds to a panic of the host kernel.

11. The system of claim 8, wherein a plurality of host kernel crash handlers are installed corresponding to a plurality of DPU devices physically connected to the host device.

12. The system of claim 8, wherein the host kernel crash handler is enabled using the instructions received from the DPU device.

13. The system of claim 8, wherein the DPU device and the host device are managed by a single enterprise that uses a management service that communicates with: a DPU management operating system comprising the host kernel, and a DPU management operating system of the DPU device.

14. The system of claim 8, wherein a component of a DPU management operating system of the DPU device performs the DPU side crash handling process.

15. A method, comprising:
installing a host kernel crash handler to a host device, the host kernel crash handler comprising instructions to provide a crash signal to a data processing unit (DPU) device physically connected to the host device;
identifying a crash of a host kernel of the host device;
triggering the host kernel crash handler based at least in part on the crash of the host kernel; and
providing, by the host kernel crash handler, the crash signal to the DPU device, causing the DPU device to execute a DPU side crash handling process.

16. The method of claim 15, wherein the host kernel crash handler is installed based at least in part on device enumeration of the host device.

17. The method of claim 15, wherein the crash corresponds to a panic of the host kernel.

18. The method of claim 15, wherein a plurality of host kernel crash handlers are installed corresponding to a plurality of DPU devices physically connected to the host device.

19. The method of claim 15, wherein the host kernel crash handler is enabled using the instructions received from the DPU device.

20. The system of claim 8, wherein a component of a DPU management operating system of the DPU device performs the DPU side crash handling process.
